(19) United States
(12) Patent Application Publication
(10) Pub. No.: US 2006/0082501 A1
(43) Pub. Date: Apr. 20, 2006

(54) Method and apparatus for direction finding using phase comparison

(75) Inventor: Bing A. Chiang, Melbourne, FL (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/026,293

(22) Filed: Dec. 30, 2004

Related U.S. Application Data
(60) Provisional application No. 60/619,095, filed on Oct. 15, 2004.

(51) Int. Cl. G01S 5/04

(52) U.S. Cl. 342/442

(57) ABSTRACT

A method and apparatus for direction-finding in elevation using only phase comparison of the received signals are disclosed. The apparatus comprises a vertical linear array, a combiner and a comparator. The vertical antenna array comprises a plurality of antennas and detects signals from a signal source. The combiner combines the detected signals to generate a direction-finding phase signal. The comparator compares the direction-finding phase signal with a phase reference signal derived from a signal received from one of the antennas.

### CROSS REFERENCE TO RELATED APPLICATION

This application claims the benefit of U.S. Provisional Application No. 60/619,095 filed Oct. 15, 2004, which is incorporated by reference as if fully set forth.

### FIELD OF INVENTION

The present invention is related to an antenna. More particularly, the present invention is related to a method and apparatus for direction finding in elevation using only a phase comparison of received signals.

### BACKGROUND

Capacity is one of the most important issues in wireless communication systems. One way to increase the capacity of a wireless communication system is to utilize a directional beam antenna. In order to use a directional beam antenna more efficiently, it is important to determine the direction of arrival (DOA) of a signal from the signal source and to point an antenna accurately toward the signal source.

One method of determining the DOA compares the amplitudes of two incoming signals. Since the ratio of the amplitudes is a function of the angle between the two signals, this amplitude comparison approach can be utilized to derive DOA. Utilizing this approach, however, can lead to ambiguous results.

FIG. 1 is a radiation plot of a two-element array spaced a half-wavelength apart. The E-Sum plot is from a sum mode, and the E-Diff plot is from a difference mode. The case where the two elements are fed in phase is called a sum mode; and where they are fed in opposite phases, a difference mode is generated. The sum pattern has a peak at horizon, (i.e., the depression angle is 90 degrees as measured from the zenith). At that same angle, the difference pattern has a deep null. Sequentially sampling the two amplitude patterns and using that information to calculate their ratio can yield the information leading to the direction of the signal. Detecting them simultaneously and forming the ratio yields instant information regarding the angle of arrival.

However, the amplitude plots are symmetrical about the 90-degree plane, (i.e., horizontal plane). Therefore, an ambiguity exists in determining the direction of arrival in elevation. In order to pinpoint a target and to provide a higher gain, more accurate elevation information is needed.

### SUMMARY

The present invention is a method and apparatus for direction finding in elevation using only a phase comparison of signals coming through two separate channels, although such signals originate as the same signal. The apparatus comprises a vertical linear antenna array, a combiner and a comparator. The vertical linear antenna array comprises a plurality of antennas, each of which detects a signal. The combiner combines the detected signals to generate a direction-finding phase signal. The comparator compares the direction-finding phase signal with a phase reference signal derived from a signal received on one of the plurality of antennas, or from another antenna dedicated for the reference signal.

### BRIEF DESCRIPTION OF THE DRAWINGS

FIG. 1 is a radiation plot of a two-element array spaced one-half wavelength apart.

FIG. 2 is a block diagram of an antenna array for direction finding in elevation.

FIG. 3 is a signal diagram of radiation phase plots of the sum and difference modes of a two-element array spaced one-half wavelength apart.

FIG. 4 is a block diagram of an antenna array for direction finding in elevation.

FIG. 5 is a flow diagram of a process for direction finding in elevation.

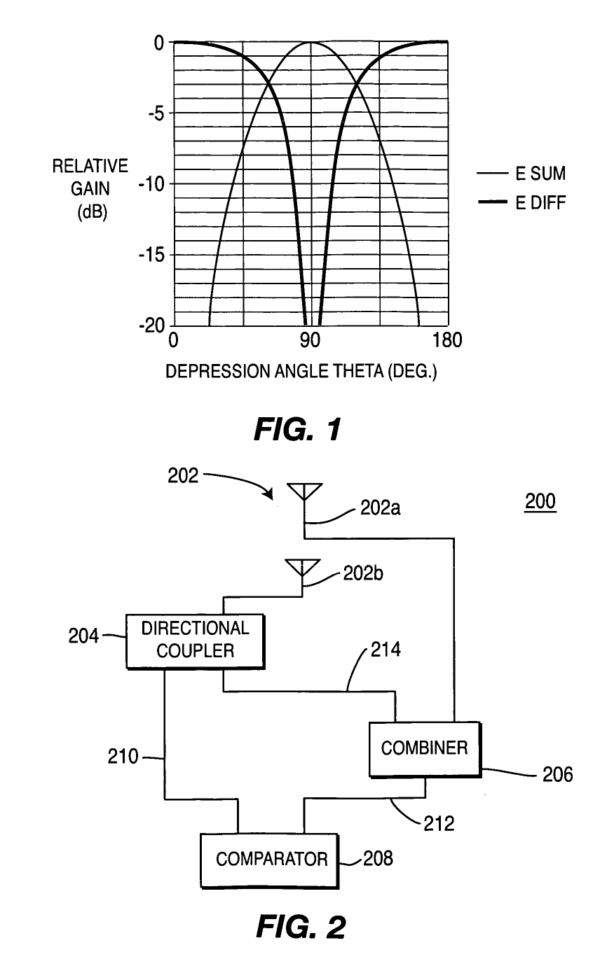

### DETAILED DESCRIPTION OF THE PREFERRED EMBODIMENTS

The present invention may be implemented in a wireless transmit/receive unit (WTRU) or in a base station. The terminology “WTRU” includes but is not limited to a user equipment, a mobile station, a fixed or mobile subscriber unit, a pager, or any other type of device capable of operating in a wireless environment. The terminology “base station” includes but is not limited to a Node-B, a site controller, an access point or any other type of interfacing device in a wireless environment.

In a preferred embodiment, a vertical linear antenna array is used for direction finding in elevation. Further, the present embodiment utilizes only phase comparison which provides a direction of arrival (DOA) without ambiguity. Direction finding in accordance with the present embodiment may be applied to direction finding in azimuth, in elevation, or both.

Referring to FIG. 2, a diagram of an antenna array 200 with a phase comparison network for direction finding in elevation in accordance with the present embodiment is shown. It should be noted that the phase comparison network shown in FIG. 2 is one possible configuration. Many other configurations may be implemented without departing from the teachings of the present invention. For simplicity, FIG. 2 shows a vertical linear antenna array 202 having only two antennas 202a, 202b, and hereinafter the present embodiment will be explained with reference to the antenna array 202 having only two antennas 202a, 202b. However, it should be understood that FIG. 2 is provided solely for illustration and not as a limitation. As is apparent to those skilled in the art, an antenna array may comprise more than two antennas without departing from the teachings of the present invention. For example, antenna element 202b may be placed above antenna element 202a. Additionally, two or more antenna elements may be spaced one-half wavelength apart with a dedicated element positioned as a reference element.

The antenna array 200 comprises a vertical linear antenna array 202, a combiner 206, a directional coupler 204 and a comparator 208. The vertical linear antenna array 202 further comprises a plurality of antennas 202a, 202b which are disposed in vertical space separated by a predetermined distance, preferably one-half wavelength. Each antenna 202a, 202b detects incoming signals. One antenna 202b feeds the detected signals to the directional coupler 204 and the other antenna 202a feeds the detected signals to the combiner 206.

The directional coupler 204 is a passive device which couples a predetermined portion of the input transmission power through s second output port. The directional coupler 204 takes a small amount of power from the antenna 202b to generate a phase reference signal 210. The phase reference signal 210 is fed into the comparator 208. Since the directional coupler 204 has a low coupling-ratio, the power of the detected signal 214, (after the phase reference signal 210 is taken out), is practically unchanged. Therefore, this signal 214 is input in to the combiner 206 along with the signal detected by antenna 202a to generate a direction finding phase signal 212, as explained in more detail below. It should be noted that, as an alternative, the directional coupler 204 can be substituted with a power divider, preferably an uneven power divider. The detected signal is divided by the power divider, and a portion of the power is fed to the combiner 206 and the remaining power is fed to the comparator 208.

In this embodiment, since there are only two antennas, signals detected by each antenna 202a, 202b are combined by the combiner 206 to generate a direction-finding phase signal 212 which is then fed into the comparator 208. The combiner 206 generates a sum mode output, a difference mode output, or both. The sum mode output is generated by feeding the detected signals in-phase, while the difference mode output is generated by feeding the detected signals out-of-phase. Typically, detected signals have different amplitudes and phases. Accordingly, the amplitude and phase of the combined signal depends on whether the amplitudes and phases of the detected signals cancel or add each other. The direction-finding phase signal 212 is preferably provided by the sum mode output, even though a difference mode output may be used as an alternative. A power divider may be used for generating a sum mode output.

The comparator 208 then compares the direction-finding phase signal 212 and the phase reference signal 210. The phase difference between the direction-finding phase signal 212 and the phase reference signal 210 corresponds to the DOA in elevation.

Alternatively, a variable electronic phase shifter may be used at the output of one of the antennas 202a, 202b. The phase shifter changes the phase of the detected signals, such that if the phase shifter is set to zero, a sum mode is generated by the combiner 206 and if the phase shifter is set to 180, a difference mode is generated by the combiner 206.

In conjunction with a phase shifter, beam steering can be implemented. This is implemented by moving an output from the comparator 208 and feeding a command back to the phase shifter to change the phase of a detected signal until the comparator 208 reads ninety degrees, (or whatever the calibrated value should be in view of an element pattern multiplication factor). In this manner, a beam can point at the direction of arrival (DOA).

To yield a more precise result, the phase shifter can be controlled until the comparator 208 reads a zero degree phase, which is the pointing angle of the null. The sum beam pointing at the same angle is obtained by adding 180 degrees to the phase shifter. This approach avoids having to use the element pattern factor.

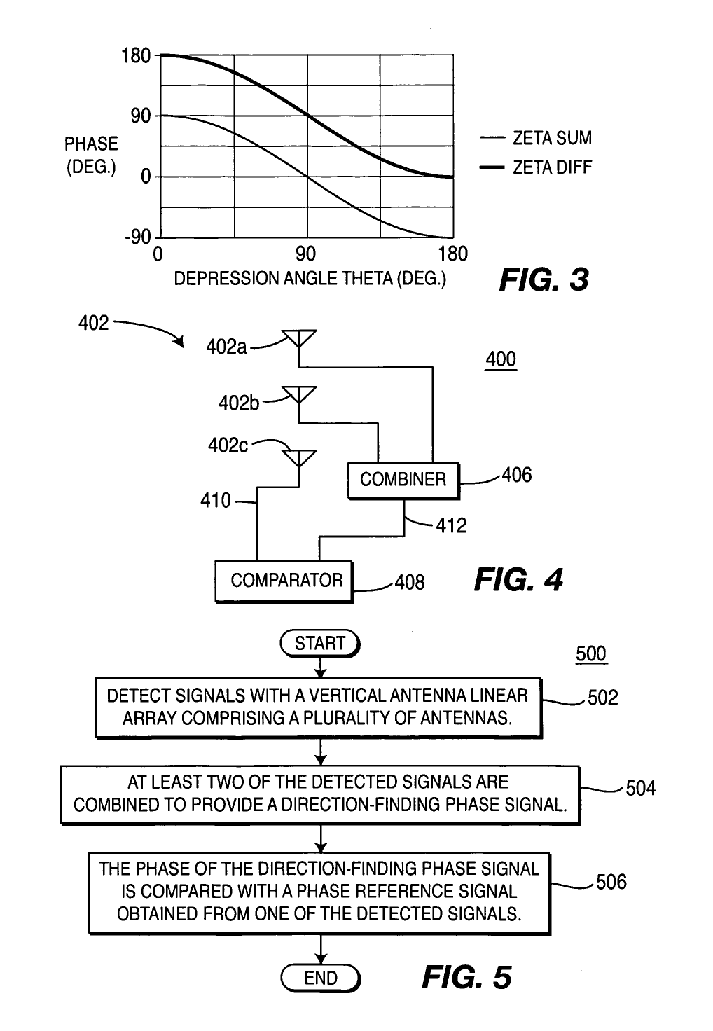

FIG. 3 illustrates radiation phase plots of a sum mode (“Zeta Sum”) and a difference mode (“Zeta Diff”). Phase plots in sum mode and difference mode are identical but translated by ninety degrees in phase. The radiation phase plots in FIG. 3 are drawn using one of the antenna elements as the phase reference signal. The phase of each beam is a monotonic function of the angle of arrival in the depression angular range. As a result, there is no ambiguity in finding the DOA in elevation utilizing a phase comparison, which is not the case when utilizing amplitude comparison. As shown in FIG. 3, the slope is greatest at the horizon, thus it is most accurate for detecting the angle of arrival near the horizon. The accuracy of direction-finding depends on the phase noise present, which is a function of the particular receiver system and the environment.

The sum mode and the difference mode contain the same information, thus only one is needed. The sum mode is preferred because the sum mode can be used as a communication beam. In addition, it is broader in bandwidth by virtue of having no phase difference in the two combining branches. The sum mode is the beam used for communication while the difference mode directs nulls and is not used for communication. The sum mode brings together the transmission lines from two antennas with equal lengths. The phases of equal-length lines have no phase difference as frequency changes. The difference mode can be formed by lines that differ in length by one-half a wavelength. The half-wavelength will not remain fixed when the physical length is fixed as the frequency varies. This reduces the bandwidth. Even if fixed phase shifters are used, there are some ripples that affect the bandwidth.

FIG. 4 is a block diagram of an antenna array 400 for direction-finding in elevation in accordance with an alternative embodiment of the present invention. The antenna array 400 comprises a vertical linear antenna array 402, a combiner 406, and a comparator 408. The vertical linear antenna array 402 comprises a plurality of antennas 402a, 402b, 402c which are disposed in vertical space separated by a predetermined distance, preferably one-half wavelength. Each antenna 402a, 402b, 402c detects incoming signals. At least two antennas 402a, 402b feed the detected signals to the combiner 406 to generate a direction-finding phase signal 412, and one antenna 402c feeds its detected signal, for use as a phase reference signal 410, directly to the comparator 408. The comparator 408 compares the direction-finding phase signal 412 and the phase reference signal 410. The phase difference between the direction-finding phase signal 412 and the phase reference signal 410 corresponds to the DOA in elevation.

It should be noted that if an antenna array in accordance with the present invention comprises three or more antenna elements, (as in FIG. 4), then one of these antenna elements preferably feeds its detected signal directly into a comparator to serve as a phase reference signal. The remaining signals are combined in a combiner. If however, the antenna array comprises only two antennas, (as illustrated in FIG. 2), a signal detected by one of the antennas is first fed into a coupler where a phase reference signal is generated and fed into a comparator. Both detected signals are then combined into a combiner so that a direction-finding signal may be generated and compared with the phase reference signal.

FIG. 5 is a flow diagram of a process 500 for direction finding in elevation in accordance with the present invention. Signals transmitted from a transmitter whose direction is at issue are detected with a vertical linear antenna array (step 502). The vertical linear antenna array comprises a plurality of antennas which are vertically disposed and separated by a predetermined distance, preferably, (but not necessarily), one-half wavelength. The detected signals are coupled to provide a direction-finding phase signal (step 504). The signals may be combined in-phase to generate a sum mode output, or may be combined out-of-phase to generate a difference mode output. The combined signal is compared with a phase reference signal which, depending on the number of antennas (as explained above), is either one of the detected signals or derived from one of the detected signals (step 506). The result of the comparison, (i.e., a phase difference between the combined signal and the phase reference signal), corresponds to the DOA in elevation.

Although the elements in the Figures are illustrated as separate elements, these elements may be implemented on a single integrated circuit (IC), such as an application specific integrated circuit (ASIC), multiple ICs, discrete components, or a combination of discrete components and IC(s). Although the features and elements of the present invention are described in the preferred embodiments in particular combinations, each feature or element can be used alone without the other features and elements of the preferred embodiments or in various combinations with or without other features and elements of the present invention. Furthermore, the present invention may be implemented in any type of wireless communication system.

What is claimed is:

1. An antenna array for detecting a direction of arrival in elevation, the antenna array comprising:
a vertical linear antenna array comprising a plurality of antennas for detecting signals;
a combiner for combining the signals detected by at least two of the antennas to provide a direction-finding phase signal; and
a comparator for comparing the direction-finding phase signal with a phase reference signal derived from a signal received from one of the antennas, wherein the result of said comparison corresponds to the direction of arrival in elevation.

2. The antenna array of claim 1 wherein the combiner generates a sum mode output by feeding the detected signals in-phase.

3. The antenna array of claim 1 wherein the combiner is a power divider.

4. The antenna array of claim 1 wherein the combiner generates a difference mode output by feeding the detected signals out-of-phase.

5. The antenna array of claim 1 wherein the antenna array comprises two elements which are spaced one-half wavelength apart.

6. The antenna array of claim 1 wherein the phase reference signal is obtained by a directional coupler.

7. The antenna array of claim 1 wherein the linear antenna array comprises three antenna elements and signals detected by two antenna elements are combined to generate the direction-finding phase signal, and a signal detected by the third antenna element is used as the phase reference signal.

8. The antenna array of claim 1 further comprising a phase shifter for shifting a phase of the detected signal, whereby the detected signal is phase shifted before entered into the combiner.

9. The antenna array of claim 8 further comprising a means for steering a beam by feeding back an output of the comparator, whereby the beam is steered in accordance with the output of the comparator.

10. The antenna array of claim 9 wherein the phase shifter is adjusted until the output of the comparator becomes 90 degrees.

11. The antenna array of claim 9 wherein the phase shifter is adjusted until the output of the comparator becomes 180 degrees.

12. A method of detecting a direction of arrival in elevation, the method comprising:
detecting signals with a vertical linear antenna array comprising a plurality of antennas;
combining the signals detected by at least two of the antennas to provide a direction-finding phase signal; and
comparing the phase of the direction-finding phase signal with a phase reference signal derived from a signal received from one of the antennas.

13. The method of claim 12 wherein a sum mode output generated by coupling the detected signals in phase is generated as a direction-finding phase signal.

14. The method of claim 12 wherein the sum mode output is generated by a power divider.

15. The method of claim 12 wherein a difference mode output is generated by coupling the detected signals out-of-phase as a direction-finding phase signal.

16. The method of claim 12 wherein the antenna array comprises two elements which are spaced one-half wavelength apart.

17. The method of claim 12 wherein the phase reference signal is obtained by a directional coupler.

18. The method of claim 12 wherein the linear antenna array comprises three antenna elements and signals detected by two elements are combined to generate the direction-finding phase signal, and a signal detected by the third antenna element is used as the phase reference signal.

19. The method of claim 12 wherein the detected signal is phase shifted before combined to generate a direction-finding phase signal.

20. The method of claim 19 further comprising a step for steering a beam by feeding back an output of the comparator, whereby the beam is steered in accordance with the output of the comparator.

21. The method of claim 20 wherein the phase shifter is adjusted until the output of the comparator becomes 90 degrees.

22. The method of claim 20 wherein the phase shifter is adjusted until the output of the comparator becomes 180 degrees.
